(19) United States
(12) Patent Application Publication
(10) Pub. No.: US 2002/0087460 A1
(43) Pub. Date: Jul. 4, 2002

(54) Method for identity theft protection

(76) Inventor: Katharine A. Hornung, Richmond, VA (US)

Correspondence Address: Kimberly A. Chasteen, Williams Mullen, Suite 210, One Old Oyster Point Road, Newport News, VA, 23602, US

(21) Appl. No.: 10/037,203

(22) Filed: Jan. 4, 2002

Related U.S. Application Data
(60) Provisional application No. 60/259,737, filed on Jan. 4, 2001.

(51) Int. Cl. G06F 17/60

(52) U.S. Cl. 705/38

(57) ABSTRACT

A method for protecting against identity theft by monitoring a consumer's credit information. The consumer's initial credit information is verified. The credit information is then monitored for changes in personal information or open credit. If changes are made, the consumer is notified. Unauthorized or invalid changes are corrected. In this manner, unauthorized attempts to open credit in the consumer's name are quickly identified and corrected, thus protecting against theft of the consumer's identity by a third party.

### CROSS REFERENCE TO RELATED APPLICATION

The present application claims priority from U.S. provisional application Ser. No. 60/259,737, filed Jan. 4, 2001.

### BACKGROUND OF THE INVENTION

1. Technical Field of the Invention

The present invention pertains to methods for identity theft protection for consumers and more particularly to a method for protecting consumers from identity theft by monitoring the consumer's credit information.

2. Discussion of the Related Art

Identity theft is a rising crime across America. There are currently many resources available to consumers, which outline precautionary measures to avoid having one's identity easily stolen. However, because of the numerous uses of an individual's social security number and other private information used to confirm identity, it is not easy to prevent someone from accessing all private information. Although consumers can take precautionary measures to prevent their identities from being easily stolen, such as not using one's social security number on one's driver's license, there is nothing they can do to guarantee that their identities will not be stolen. Currently no method exists for discovering an attempted identity theft at an early stage before significant damage is caused. Additionally, there is currently no system in place to assist consumers in easily monitoring their credit header information and open lines of credit across multiple credit reporting agencies. By monitoring open lines of credit, a potential identity theft occurrence can be quickly identified and the damage mitigated. This invention identifies a process to confirm and monitor the validity of all open lines of credit associated with an individual, and services necessary to confirm and correct any cases of mistaken or stolen identity.

It is accordingly an object of the present invention to provide a method for minimizing the risk of identity theft for a consumer.

It is a further object of the present invention to provide a method for minimizing the risk of identity theft for a consumer by means of monitoring the consumer's credit information.

It is a further object of the present invention to provide a method for minimizing the risk of identity theft for a consumer by verifying new credit requests with the consumer.

It is yet a further object of the present invention to provide a method for minimizing the risk of identity theft for a consumer by verifying any changes in the consumer's credit report header with the consumer.

Finally, it is an object of the present invention to accomplish the foregoing objects in a simple manner.

Additional objects and advantages of the present invention are apparent from the drawings and specifications, which follow.

### SUMMARY OF THE INVENTION

According to the present invention, the foregoing and additional objects are obtained by providing a method for protecting a consumer against identity theft by monitoring the consumer's credit information. The method includes the steps of obtaining initial personal information from a consumer having a credit history, receiving notification of one or more changes in the consumer's credit history; and notifying the consumer of each change in the consumer's credit history. If desired, it is also possible to obtain an initial credit report for the consumer from a major credit agency such as Equifax, Experian and TransUnion or through other means available, to verify the information in this initial report with the consumer and to take actions to correct any mistakes in the consumer's personal or credit information. Finally, once notification of any changes has been received, these changes can be verified with the consumer and, if the consumer does not verify the changes, the changes can be corrected. An alternate embodiment of the invention includes similar steps, however, instead of receiving notification of any changes in the consumer's credit information, new credit reports are obtained from a credit agency or by other means on a regular basis, such as weekly, monthly or quarterly. As changes in either personal or credit information are discovered in the later obtained reports, these changes can be verified with the consumer and corrected if unauthorized or fraudulent changes are discovered. Further, along with the initial step of obtaining personal information from the consumer, credit information can be obtained as well. Then, both the personal and credit information can be checked against an initial credit report and any necessary corrections can be made.

### DETAILED DESCRIPTION OF THE PREFERRED EMBODIMENT

There are numerous credit reporting agencies in the United States, among them the three primary credit reporting agencies are: Equifax, Experian, and TransUnion. Credit reporting agencies gather all reported credit information as it pertains to consumers within their databases. The credit reporting agencies market access to their databases to companies which generally use the information for marketing or as an input to the decision process for extending credit to a consumer.

This same information used by businesses for marketing and credit granting can be easily used to protect consumers against identity thieves. By confirming the validity of all credit header information (name, address, phone number, social security number, etc.) and open lines of credit, a consumer can be secure in the knowledge that, at that time, his or her identity has not been stolen. However, because this is only a confirmation at that point in time, the credit information must be monitored and verified on an on-going basis. If any unauthorized changes do occur, the identity theft or mistaken identity can be dealt with immediately and cause as little interruption to the consumer's life as possible.

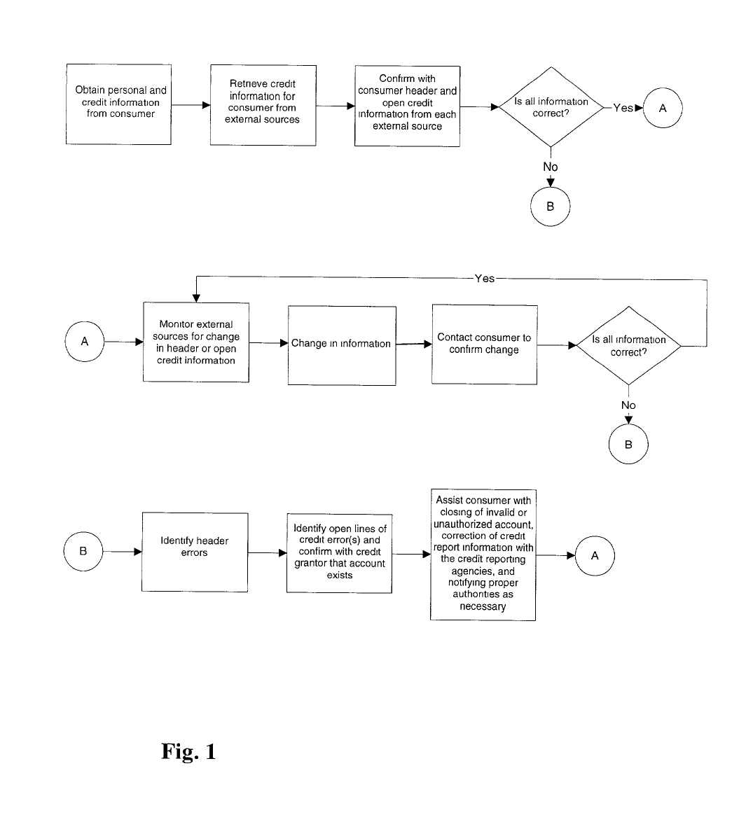

One preferred embodiment of the present invention is shown in FIG. 1. In this particular preferred embodiment, the first step is to obtain personal and, preferably, credit information from a consumer. The personal information consists of the consumer's name, current address and other identifying information reported by creditors. The consumer's credit information consists of all open credit arrangements such as credit cards, gas cards, store cards, mortgage loans, student loans and car loans. Once this information is received from the consumer, a credit report is requested from one or more of the major credit agencies. Currently the major credit agencies are Equifax, Experian, and TransUnion, however alternative methods of obtaining credit reports are also contemplated by this invention. Once the report is received, the personal and credit information in the report is compared to the information provided by the consumer. If discrepancies are found, steps are taken to remedy them. It is not necessary to obtain the credit information from the consumer. Instead, the consumer's personal information may be used to request the credit report from one or more of the major credit agencies. Once the credit report is obtained, the personal information obtained from the consumer is compared with the personal information in the credit report and the credit information in the credit report is verified with the consumer. Again, any discrepancies are remedied.

It is also possible that the consumer has recently reviewed and corrected his or her personal and credit information. In this event, it is only necessary to obtain an initial credit report and monitor the consumer's personal and credit information for changes.

In the preferred embodiment of the present invention, subsequent to verifying the consumer's initial information, notification is received of any changes to the consumer's personal or credit information as the changes occur. Once a change occurs, the consumer is contacted to verify the validity of the change. If the consumer verifies the change, no further action is taken. If the consumer does not verify the change, steps are taken to correct the change and, if appropriate, the authorities are notified that an identity theft may have occurred or may be underway.

In the alternative, the next step in the process is to obtain new credit reports at regular intervals such as weekly, monthly or quarterly. Clearly any interval acceptable to the consumer can be used. Once a new credit report is obtained, it is compared with the most recent previous report. If discrepancies in either personal information or credit information are discovered, these discrepancies are verified with the consumer. If the discrepancies are deemed valid by the consumer, no further action is taken. If the discrepancies indicate unauthorized attempts to obtain credit in the consumer's name, the unauthorized credit line is immediately closed. If the discrepancies indicate incorrect or unauthorized changes to the consumer's personal information, this can be corrected immediately. If necessary, the authorities can be notified of any apparent attempt at identity theft.

### EXAMPLE

Consumer A with an average credit history has several open lines of credit, including three credit cards, a mortgage, and a home equity line of credit. Consumer A decides to protect herself from identity theft and contacts the Company XYZ. Company XYZ requests Consumer A's private information in order to pull accurate credit reports from each of the big three credit agencies, Equifax, TransUnion and Experian.

On each of the three reports, all of the personal information regarding Consumer A's employer, address, previous addresses, etc. is correct. On two of the three reports, Consumer A's open credit line information is also correct. On one of the three credit reports, an old department store credit card account is reported as still open, although it was closed two years ago. Company XYZ facilitates Consumer A's investigation with that credit agency, to challenge and facilitate the correction of the information improperly reported about the department store credit card.

On an ongoing basis, Company XYZ will monitor Consumer A's credit history for any change in header information (employer, address, previous addresses, etc.) or any change to her lines of credit.

During this monitoring, Company XYZ is notified of a new credit card opened in Consumer A's name that appears on two of the credit reporting agencies' databases. Company XYZ contacts Consumer A to confirm that the credit card is hers. Consumer A confirms that she applied for a new card and Company XYZ resumes its monitoring process for any future changes in Consumer A's credit information.

Also during this monitoring, Company XYZ receives notification that there has been a change in Consumer A's address information on one of the credit reporting databases. Company XYZ contacts Consumer A to confirm that the change is correct. Consumer A does not confirm the change, and says that she has not moved. Company XYZ facilitates Consumer A's investigation with the credit agency, to challenge the change in and facilitate the correction of address information reported in the database. Company XYZ again resumes its monitoring process for any future changes in Consumer A's credit information.

Many improvements, modifications, and additions will be apparent to the skilled artisan without departing from the spirit and scope of the present invention as described herein and defined in the following claims.

What is claimed is:

1. A method for protecting against identity theft comprising:
a. obtaining initial personal information from a consumer having a credit history;
b. receiving notification of one or more changes in the consumer's credit history; and
c. notifying the consumer of each change in the consumer's credit history.

2. The method of claim 1 wherein step a. further comprises obtaining a first report of personal and credit information about the consumer from at least one credit agency.

3. The method of claim 2 wherein step a. further comprises verifying the first report of personal and credit information obtained from the credit agency with the consumer to identify incorrect personal or credit information.

4. The method of claim 3 wherein step a. further comprises correcting incorrect personal or credit information in the first report of personal and credit information obtained from the credit agency.

5. The method of claim 1 wherein step c. further comprises verifying each change with the consumer.

6. The method of claim 3 wherein step c. further comprises correcting each change not verified by the consumer.

7. The method of claim 2 wherein the at least one credit agency is one or more agencies selected from the group consisting of Equifax, Experian and TransUnion.

8. A method for protecting against identity theft comprising:
a. obtaining initial personal information from a consumer having a credit history;
b. obtaining a first report of personal and credit information about the consumer from at least one credit agency;
c. verifying the first report of personal and credit information obtained from the credit agency with the consumer to identify incorrect personal or credit information;
d. correcting incorrect personal or credit information in the first report of personal and credit information obtained from the credit agency
e. receiving notification of one or more changes in the consumer's credit history;
f. notifying the consumer of each change in the consumer's credit history;
g. verifying each change with the consumer; and
h. correcting each change not verified by the consumer.

9. A method for protecting against identity theft, comprising:
a. obtaining initial personal information from a consumer;
b. obtaining a first report of personal and credit information about the consumer from at least one credit agency;
c. obtaining, after a predetermined amount of time, a second report of personal and credit information about the consumer from the credit agency;
d. comparing the second report of personal and credit information obtained from the credit agency with the first personal and credit information obtained from the credit agency;
e. identifying discrepancies between the second report of personal and credit information obtained from the credit agency and the first report of personal and credit information obtained from the credit agency;
f. verifying discrepancies between the second report of personal and credit information obtained from the credit agency and the first report of personal and credit information obtained from the credit agency with the consumer;
g. correcting discrepancies not verified by the consumer between the second report of personal and credit information obtained from the credit agency with the first report of personal and credit information obtained from the credit agency; and
h. repeating steps c through g.

10. The method of claim 9 further comprising the steps
comparing the initial personal information obtained from the consumer with the first report of personal information obtained from the credit agency;
identifying discrepancies between the initial personal information obtained from the consumer and the first report of personal information obtained from the credit agency;
correcting discrepancies between the first report of personal information obtained from the credit agency and the initial personal information obtained from the consumer;
verifying the first report of credit information obtained from the credit agency with the consumer to identify incorrect credit information; and
correcting incorrect credit information in the first report of credit information obtained from the credit agency.

11. The method of claim 9 wherein the predetermined amount of time is selected from the group consisting of a day, a week, a month, a quarter, six months and a year.

12. The method of claim 9 wherein the predetermined amount of time is a week.

13. The method of claim 9 wherein the predetermined amount of time is a month.

14. The method of claim 9 wherein the at least one credit agency is one or more agencies selected from the group consisting of Equifax, Experian and TransUnion.

15. A method for protecting against identity theft, comprising:
a. obtaining initial personal and credit information from a consumer;
b. obtaining a first report of personal and credit information about the consumer from at least one credit agency;
c. obtaining, after a predetermined amount of time, a second report of personal and credit information about the consumer from the credit agency;
d. comparing the second report of personal and credit information obtained from the credit agency with the first personal and credit information obtained from the credit agency;
e. identifying discrepancies between the second report of personal and credit information obtained from the credit agency and the first report of personal and credit information obtained from the credit agency;
f. verifying discrepancies between the second report of personal and credit information obtained from the credit agency and the first report of personal and credit information obtained from the credit agency with the consumer;
g. correcting discrepancies not verified by the consumer between the second report of personal and credit information obtained from the credit agency with the first report of personal and credit information obtained from the credit agency; and
h. repeating steps c through g.

16. The method of claim 15 further comprising the steps
comparing the initial personal and credit information obtained from the consumer with the first report of personal and credit information obtained from the credit agency;
identifying discrepancies between the initial personal and credit information obtained from the consumer and the first report of personal and credit information obtained from the credit agency; and
correcting discrepancies between the first report of personal and credit information obtained from the credit agency and the initial personal and credit information obtained from the consumer.

17. The method of claim 15 wherein the predetermined amount of time is selected from the group consisting of a day, a week, a month, a quarter, six months and a year.

18. The method of claim 15 wherein the predetermined amount of time is a week.

19. The method of claim 15 wherein the predetermined amount of time is a month.

20. The method of claim 15 wherein the at least one credit agency is one or more agencies selected from the group consisting of Equifax, Experian and TransUnion.
